(19) United States
(12) Patent Application Publication
(10) Pub. No.: US 2023/0208081 A1
(43) Pub. Date: Jun. 29, 2023

(54) CARD EDGE CONNECTOR

(71) Applicant: Amphenol Commercial Products (Chengdu) Co., Ltd., Chengdu (CN)

(72) Inventors: Bing Liu, Chengdu (CN); Jun Fan, Chengdu (CN); Tao Zeng, Chengdu (CN)

(73) Assignee: Amphenol Commercial Products (Chengdu) Co., Ltd., Chengdu (CN)

(21) Appl. No.: 17/871,114

(22) Filed: Jul. 22, 2022

(30) Foreign Application Priority Data
Dec. 27, 2021 (CN) 202123312854.8

(51) Int. Cl. H01R 13/6581; H01R 12/72; H01R 13/6597

(52) U.S. Cl. CPC H01R 13/6581; H01R 12/721; H01R 12/727; H01R 13/6597

(57) ABSTRACT

A card edge connector for use with high-speed signals. The card edge connector includes a shielding member held in a base portion of a housing of the card edge connector on a side of a first terminal row of the card edge connector facing away from a second terminal row and spaced apart from the first terminal row. The shielding member is configured to overlap at least intermediate portions of a plurality of pairs of first signal terminals, and to electrically connect a plurality of ground terminals to each other. Such a configuration enables the card edge connector to meet signal integrity requirements in connectors designed for 128 Gbps and beyond, while conforming to a standard that constrains mating and mounting interfaces.

### RELATED APPLICATION

This application claims priority to and the benefit of Chinese Patent Application No. 202123312854.8, filed on Dec. 27, 2021, entitled “CARD EDGE CONNECTOR,” the entire content of which is incorporated herein by reference in its entirety.

### TECHNICAL FIELD

The present disclosure relates generally to interconnection systems, such as those including electrical connectors, used to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several printed circuit boards is to have one printed circuit board serve as a backplane. A known backplane is a PCB onto which many connectors may be mounted. Conducting traces in the backplane may be electrically connected to signal conductors in the connectors so that signals may be routed between the connectors. Other printed circuit boards, called “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may plug into the backplane at a right angle. The connectors used for these applications may therefore include a right angle bend and are often called “right angle connectors.”

Connectors may also be used in other configurations for interconnecting printed circuit boards. Sometimes, one or more printed circuit boards may be connected to another printed circuit board, called a “motherboard,” that is both populated with electronic components and interconnects the daughterboards. In such a configuration, the printed circuit boards connected to the motherboard may be called daughterboards. The daughterboards are often smaller than the motherboard and may sometimes be aligned parallel to the motherboard. Connectors used for this configuration are often called “stacking connectors” or “mezzanine connectors.” In other systems, the daughterboards may be perpendicular to the motherboard.

For example, this configuration is often used in computers in which the motherboard might have a processor and a bus configured to pass data between the processor and peripherals, such as a graphics processor or memory. Connectors may be mounted to the motherboard and connected to the bus. The peripherals may be implemented on daughtercards with connectors that mate with the connectors on the bus such that separately manufactured peripherals may be readily integrated into a computer made with the motherboard.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include serial ATA (SATA), serial attached SCSI (SAS), peripheral component interconnect express (PCIe), which are commonly used in computers. The standards have gone through multiple revisions, adapting to the higher performance expected from computers over time.

### BRIEF SUMMARY

Aspects of the present disclosure relate to high speed electrical connectors.

Some embodiments relate to a card edge connector. The card edge connector may include a housing comprising a base portion extending in a longitudinal direction and a socket recessed into the base portion in a mating direction perpendicular to the longitudinal direction; a plurality of conductive terminals held in the housing and disposed in a row extending in the longitudinal direction, the plurality of conductive terminals each comprising a first contact portion curving into the socket, a second contact portion opposite the first contact portion and disposed outside the base portion, and an intermediate portion extending between the first contact portion and the second contact portion, the plurality of conductive terminals comprising a plurality of pairs of signal terminals and a plurality of ground terminals between the pairs; and a shielding member at least partially held in the base portion and separated from the socket by the plurality of conductive terminals, the shielding member configured to overlap at least the intermediate portions of the plurality of pairs of signal terminals and to electrically connect the plurality of ground terminals.

In some embodiments, the shielding member may comprise a body, and a plurality of connection portions extending from the body and towards respective ones of the plurality of ground terminals.

In some embodiments, each intermediate portion of the plurality of ground terminals and the plurality of pairs of signal terminals may comprise a first section joining the first contact portion, a second section joining the second contact portion, and a third section joining the first section and the second section. The plurality of connection portions may be connected to the plurality of ground terminals at the third sections of the intermediate portions.

In some embodiments, contact points between the plurality of connection portions of the shielding member and the plurality of ground terminals may be closer to the second section than the first section.

In some embodiments, the third sections of the intermediate portions of the plurality of ground terminals and the plurality of pairs of signal terminals may extend in a first plane. The second sections of the intermediate portions of each of the plurality of ground terminals and the plurality of pairs of signal terminals may extend in an angle with respect to the first plane.

In some embodiments, the body of the shielding member may extend in parallel to the first plane. The body may overlap the first and third sections of the intermediate portions of the plurality of pairs of signal terminals and the plurality of ground terminals. The shielding member may comprise a plurality of extensions extending from the body and each extending in parallel to the second sections of the intermediate portions of one pair of the plurality of pairs of signal terminals.

In some embodiments, the third sections of the intermediate portions of the plurality of pairs of signal terminals and the plurality of ground terminals may be retained by the base portion. The second sections of the intermediate portions of the plurality of pairs of signal terminals and the plurality of ground terminals may extend out of the base portion. The body of the shielding member is retained in the base portion. The plurality of extensions may extend out of the base portion.

In some embodiments, the plurality of extensions may be a plurality of first extensions. The shielding member may comprise a plurality of second extensions extending from the body. The plurality of first extensions may be separated from each other by the plurality of second extensions, with one second extension between every two adjacent first extensions. Each of the plurality of second extensions may be spaced apart from two adjacent first extensions by a cutout extending into the body and disposed corresponding to one of the plurality of ground terminals.

In some embodiments, the card edge connector may further comprise one or more signal terminals and/or power terminals disposed in the row.

Some embodiments relate to a card edge connector. The card edge connector may include a housing comprising a base portion extending in a longitudinal direction and a socket recessed into the base portion in a mating direction perpendicular to the longitudinal direction; a plurality of conductive elements held in the housing and disposed in a row extending in the longitudinal direction, the plurality of conductive terminals each comprising a first contact portion curving into the socket, a second contact portion opposite the first contact portion and disposed outside the base portion, and an intermediate portion joining the first contact portion and the second contact portion; and a shielding member comprising: a body at least partially held in the base portion; and a plurality of extensions extending from and transverse to the body and out of the base portion and closer to the second contact portions of the plurality of conductive elements.

In some embodiments, the plurality of conductive elements may be a first plurality of conductive elements disposed in a first row. The shielding member may be a first shielding member. The card edge connector may comprise a second plurality of conductive elements held in the housing and disposed in a second row in the longitudinal direction and separated from the first row by the socket, the second plurality of conductive terminals each comprising a first contact portion curving into the socket, a second contact portion opposite the first contact portion and disposed outside the base portion, and an intermediate portion joining the first contact portion and the second contact portion, the second plurality of conductive terminals comprising a plurality of pairs of signal terminals and a plurality of ground terminals dispersed between the pairs; and a second shielding member held in the base portion and separated from the socket by the second plurality of conductive terminals. The second shielding member may comprise a body at least partially held in the base portion and a plurality of extensions extending from and transverse to the body and out of the base portion and closer to the second contact portions of the second plurality of conductive elements.

In some embodiments, the second shielding member may comprise a plurality of connection portions. Each of the plurality of connection portions may extend from the body of the second shielding member towards a corresponding one ground terminal of the plurality of ground terminals and may be electrically connected to the corresponding one ground terminal at the intermediate portions. The plurality of connection portions of the second shielding member may be offset from the plurality of connection portions of the first shielding member in the longitudinal direction.

In some embodiments, the card edge connector may further comprise a third shielding member disposed in the base portion between the first row and the second row and electrically connected to the first shielding member and the second shielding member.

In some embodiments, the third shielding member may be made of a lossy material.

In some embodiments, the third shielding member may be electrically connected to the plurality of ground terminals at the intermediate portions.

In some embodiments, the card edge connector may further comprise a first receiving portion and a second receiving portion extending from the base portion at opposite ends of the base portion, respectively. The first receiving portion and the second receiving portion may be configured to guide, receive and/or retain edges of a printed circuit board. When the edges of the printed circuit board are received in the first receiving portion and the second receiving portion, a portion of the printed circuit board may be disposed between the second contact portions of the first row and the second row.

Some embodiments relate to an electrical connector. The electrical connector may include a housing comprising a base portion extending in a longitudinal direction, a socket recessed into the base portion in a mating direction perpendicular to the longitudinal direction, and a pair of guide members extending from the base portion in the mating direction; a plurality of conductive elements held in the housing and disposed in a row extending in the longitudinal direction, the plurality of conductive terminals each comprising a first contact portion curving into the socket, and a second contact portion opposite the first contact portion and disposed outside the base portion and between the pair of guide members; and a shielding member at least partially held in the base portion and extending at least from the first contact portions of the plurality of conductive elements to the second contact portions of the plurality of conductive elements.

In some embodiments, the plurality of conductive elements may comprise a plurality of pairs of signal terminals and a plurality of ground terminals dispersed between the pairs. The shielding member may comprise a body, a plurality of first extensions extending from the body and each disposed to overlap one pair of the plurality of pairs of signal terminals, and a plurality of second extensions extending from the body and each disposed corresponding to one of the plurality of ground terminals. The plurality of second extensions may each comprise a slot disposed to overlap a respective one of the plurality of ground terminals.

In some embodiments, the shielding member may comprise a plurality of connection portions configured to make contact with portions of the plurality of ground terminals in the base portion of the housing, and a plurality of extension extending out of the base portion and closer to the second contact portions of the plurality of conductive elements.

Some embodiments relate to an electronic system. The electronic system may include an electrical connector described herein; a first printed circuit board inserted into the socket of the electrical connector, the first printed circuit board comprising a first plurality of contact pads configured to make contact with the first contact portions of the plurality of conductive terminals; and a second printed circuit board inserted between the pair of guide members, the second printed circuit board comprising a second plurality of contact pads configured to make contact with the second contact portions of the plurality of conductive terminals. The shielding member of the electrical connector may be separated from the first and second printed circuit boards by the plurality of conductive elements.

According to an aspect of the present application, a card edge connector for establishing an electrical connection between a first circuit board and a second circuit board is provided. The card edge connector may comprise: an insulative housing including a base portion extending along a longitudinal direction and a socket recessed into the base portion along a mating direction perpendicular to the longitudinal direction from a first side of the base portion; a plurality of conductive terminals each including a first contact portion, a second contact portion opposite to the first contact portion, and an intermediate portion extending between the first contact portion and the second contact portion, the plurality of conductive terminals held in the insulative housing and arranged in a first terminal row and a second terminal row extending along the longitudinal direction respectively, mutually opposed and spaced apart, with the first contact portion exposed in the socket for establishing an electrical connection with a first corresponding conductive portion of the first circuit board when the first circuit board is inserted into the socket, and with the second contact portion protruding out of a second side of the base portion opposite to the first side for establishing an electrical connection with a second corresponding conductive portion of the second circuit board, the first terminal row including a plurality of first ground terminals and a plurality of pairs of first signal terminals, each pair of the plurality of pairs of first signal terminals constituting a differential signal pair for carrying a differential signal, and the plurality of pairs of first signal terminals spaced apart from each other by the plurality of first ground terminals, with one first ground terminal disposed between every two adjacent pairs of the first signal terminals; and a first shielding member held in the base portion on a side of the first terminal row facing away from the second terminal row and spaced apart from the first terminal row, the first shielding member configured for covering at least the intermediate portions of the plurality of pairs of first signal terminals in the longitudinal direction and the mating direction, and electrically connecting the plurality of first ground terminals together.

In some embodiments, the first shielding member may include a plurality of first connection portions, each of the plurality of first connection portions may extend from the first shielding member towards a corresponding one first ground terminal of the plurality of first ground terminals and electrically connected to the corresponding one first ground terminal at the intermediate portion thereof, thereby electrically connecting the corresponding one first ground terminal to the first shielding member.

In some embodiments, each of the intermediate portion of each of the plurality of first ground terminals and the intermediate portion of each first signal terminal of the plurality of pairs of first signal terminals may include a first section connected with the first contact portion, a second section connected with the second contact portion, and a third section connecting the first section with the second section and extending parallelly to the mating direction, and wherein each of the plurality of first connection portions may be connected to the corresponding one first ground terminal on the third section of the intermediate portion of the corresponding one first ground terminal.

In some embodiments, the position where each of the plurality of first connection portions is connected to the third section of the intermediate portion of the corresponding one first ground terminal may be closer to the second section, rather than to the first section.

In some embodiments, each first signal terminal of the plurality of pairs of first signal terminals and each first ground terminal of the plurality of first ground terminals may be aligned along the longitudinal direction, and wherein the third section of the intermediate portion of each of the plurality of first ground terminals and the third section of the intermediate portion of each first signal terminal of the plurality of pairs of first signal terminals may collectively define a first plane, the second section of the intermediate portion of each of the plurality of first ground terminals and the second section of the intermediate portion of each first signal terminal of the plurality of pairs of first signal terminals may extend obliquely away from the first plane, respectively.

In some embodiments, the first shielding member may include a first body extending parallelly to the first plane and a plurality of first extensions extending from the first body, the first body may cover the first and third sections of the intermediate portions of the plurality of pairs of first signal terminals and the plurality of first ground terminals in the longitudinal and mating directions, each of the plurality of first extensions may extend along and parallelly to the second sections of two intermediate portions of a corresponding pair of the plurality of pairs of first signal terminals.

In some embodiments, the third sections of the intermediate portions of the plurality of pairs of first signal terminals and the third sections of the intermediate portions of the plurality of first ground terminals may be retained by the base portion, and wherein the second sections of the intermediate portions of the plurality of pairs of first signal terminals and the second sections of the intermediate portions of the plurality of first ground terminals may extend out of the second side of the base portion, the first body of the first shielding member may be retained in the base portion, and each of the plurality of first extensions may protrude out of the second side of the base portion.

In some embodiments, the first shielding member may include a plurality of second extensions extending from the first body, the plurality of first extensions spaced apart from each other by the plurality of second extensions, with one second extension between every two adjacent first extensions, and each of the plurality of second extensions may be spaced apart from two adjacent first extensions by a cutout cut into the first body, wherein each of the plurality of first connection portions may be a spring arm extending from the first shielding member and may be at least partially punched integrally from a corresponding one of the plurality of second extensions, the spring arm may abut against the third section of the intermediate portion of the corresponding one first ground terminal.

In some embodiments, each of the plurality of first connection portions may be a spring arm integrally punched from the first shielding member, the spring arm may abut against the intermediate portion of the corresponding one first ground terminals.

In some embodiments, the first shielding member may include a first retention feature configured for retaining the first shielding member in the base portion, the first retention feature may be a protruding feature protruding from the first shielding member beyond a surface of the first shielding member facing away from the first terminal row.

In some embodiments, the total number of the first signal terminals and the first ground terminals may be less than the total number of the conductive terminals in the first terminal row, the plurality of first ground terminals and the plurality of pairs of first signal terminals constitute a zone of the first terminal row, wherein two first ground terminals of the plurality of first ground terminals may be arranged at each end of the zone along the longitudinal direction, respectively, and the first terminal row may further include signal terminals and/or power terminals arranged on each side of the zone of the first terminal row.

In some embodiments, the second terminal row may include a plurality of second ground terminals and a plurality of pairs of second signal terminals arranged opposing to the plurality of first ground terminals and the plurality of pairs of first signal terminals, each pair of the plurality of pairs of second signal terminals may constitute a differential signal pair for carrying a differential signal, and the plurality of pairs of second signal terminals spaced apart from each other by the plurality of second ground terminals, with one second ground terminal disposed between every two adjacent pairs of the second signal terminals. The card edge connector may further include a second shielding member held in the base portion on a side of the second terminal row facing away from the first terminal row and spaced apart from the second terminal row, the second shielding member may be configured for covering at least the intermediate portions of the plurality of pairs of second signal terminals in the longitudinal direction and the mating direction, and electrically connecting the plurality of second ground terminals together.

In some embodiments, the second shielding member may include a plurality of second connection portions, each of the plurality of second connection portions may extend from the second shielding member towards a corresponding one second ground terminal of the plurality of second ground terminals and may be electrically connected to the corresponding one second ground terminal at the intermediate portion thereof, thereby electrically connecting the corresponding one second ground terminal to the second shielding member.

In some embodiments, each of the intermediate portion of each of the plurality of second ground terminals and the intermediate portion of each second signal terminal of the plurality of pairs of first signal terminals may include a fourth section connected with the first contact portion, a fifth section connected with the second contact portion, and a sixth section connecting the fourth section with the fifth section and extending parallelly to the mating direction, each of the plurality of second connection portions may be connected to the corresponding one second ground terminal on the sixth section of the intermediate portion of the corresponding one second ground terminal.

In some embodiments, the position where each of the plurality of second connection portions is connected to the sixth section of the intermediate portion of the corresponding one second ground terminal may be closer to the fifth section, rather than to the fourth section.

In some embodiments, each second signal terminal of the plurality of pairs of second signal terminals and each second ground of the plurality of second ground terminals may be aligned along the longitudinal direction, and wherein the sixth section of the intermediate portion of each of the plurality of second ground terminals and the sixth section of the intermediate portion of each second signal terminal of the plurality of pairs of second signal terminals may collectively define a second plane, the fifth section of the intermediate portion of each of the plurality of second ground terminals and the fifth section of the intermediate portion of each second signal terminal of the plurality of pairs of second signal terminals may extend obliquely away from the second plane, respectively.

In some embodiments, the second shielding member may include a second body extending parallelly to the second plane and a plurality of third extensions extending from the second body, the second body may cover the fourth and sixth sections of the intermediate portions of the plurality of pairs of second signal terminals and the plurality of second ground terminals in the longitudinal and mating directions, each of the plurality of second extensions may extend along and parallelly to the fifth sections of two intermediate portions of a corresponding pair of the plurality of pairs of second signal terminals.

In some embodiments, the sixth sections of the intermediate portions of the plurality of pairs of second signal terminals and the sixth sections of the intermediate portions of the plurality of second ground terminals may be retained by the base portion, and wherein the fifth sections of the intermediate portions of the plurality of pairs of second signal terminals and the fifth sections of the intermediate portions of the plurality of second ground terminals may extend out of the second side of the base portion, the second body of the second shielding member may be retained in the base portion, and each of the plurality of second extensions may protrude out of the second side of the base portion.

In some embodiments, the second shielding member may include a plurality of fourth extensions extending from the second body, the plurality of third extensions are spaced apart from each other by the plurality of fourth extensions, with one fourth extension between every two adjacent third extensions, and each of the plurality of fourth extensions may be spaced apart from two adjacent third extensions by a cutout cut into the second body, wherein each of the plurality of second connection portions may be a spring arm extending from the second shield and may be at least partially punched integrally from a corresponding one of the plurality of fourth extensions, the spring arm may abut against the sixth section of the intermediate portion of the corresponding one second ground terminal.

In some embodiments, each of the plurality of second connection portions may be a spring arm integrally punched from the second shielding member, the spring arm may abut against the intermediate portion of the corresponding one second ground terminals.

In some embodiments, the second shielding member may include a second retention feature configured for retaining the second shielding member in the base portion, the second retention feature may be a protruding feature protruding from the second shielding member beyond a surface of the second shielding member facing away from the second terminal row.

In some embodiments, the total number of the second signal terminals and the second ground terminals may be less than the total number of the conductive terminals in the second terminal row, the plurality of second ground terminals and the plurality of pairs of second signal terminals may constitute a zone of the second terminal row, wherein two second ground terminals of the plurality of second ground terminals may be arranged at each end of the zone along the longitudinal direction, respectively, and the second terminal row may further include signal terminals and/or power terminals arranged on each side of the zone of the second terminal row.

In some embodiments, the number of the first signal terminals may be the same as that of the second signal terminals, and the number of the first ground terminals may be the same as that of the second ground terminals, the plurality of first ground terminals and the plurality of pairs of first signal terminals may be spaced apart from the plurality of second ground terminals and the plurality of pairs of second signal terminals opposing to each other and offset from each other.

In some embodiments, the card edge connector may further comprise a third shield member disposed in the base portion between the first terminal row and the second terminal row, the third shield member may electrically couple the plurality of first ground terminals and the plurality of second ground terminals together.

In some embodiments, the third shield member may be made of a metal and electrically connect the plurality of first ground terminals and the plurality of second ground terminals together.

In some embodiments, the third shield member may be made of a lossy material, and the third shield member may be capacitively coupled or in direct contact with the plurality of first ground terminals and the plurality of second ground terminals.

In some embodiments, the third shield member may be electrically coupled with each ground terminal of the plurality of first ground terminals and the plurality of second ground terminals at the intermediate portion of the ground terminal.

In some embodiments, the card edge connector may further comprise a first receiving portion and a second receiving portion extending from the second side of the base portion at each end of the base portion along the longitudinal direction, respectively, the first receiving portion and the second receiving portion may be configured to guide, receive and retain an edge of the second circuit board, when the edge of the second circuit board may be received in the first receiving portion and the second receiving portion, a portion of the second circuit board provided with the second corresponding conductive portion may be located between the second contact portions of the first terminal row and the second terminal row and the second contact portions establish an electrical connection with the second corresponding conductive portion.

In some embodiments, the first body of the first shielding member may be continuously flat in the longitudinal direction and the mating direction.

In some embodiments, the second body of the second shielding member may be continuously flat in the longitudinal direction and the mating direction.

These techniques may be used alone or in any suitable combination. The foregoing summary is provided by way of illustration and is not intended to be limiting.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1A is a perspective view of an electronic system including a card edge connector, according to some embodiments;

FIG. 1B is an exploded perspective view of the electronic system of FIG. 1A;

FIG. 2A is a top, front perspective view of the card edge connector of FIG. 1A;

FIG. 2B is a side, rear perspective view of the card edge connector of FIG. 2A;

FIG. 2C is a front elevation view of the card edge connector of FIG. 2A;

FIG. 2D is a rear elevation view of the card edge connector of FIG. 2A;

FIG. 3 is a top, front perspective view of a portion of the card edge connector of FIG. 2A, showing conductive terminals, a first shielding member and a second shielding member ;

FIG. 4A is a top plan view of a zone of the first terminal row of the conductive terminals of FIG. 3 configured for transmitting differential signals;

FIG. 4B is a top plan view of the zone of FIG. 4A and the first shielding member of FIG. 3;

FIG. 4C is a top, side perspective view of the zone and the first shielding member of FIG. 4B;

FIG. 4D is a front elevation view of the zone and the first shielding member of FIG. 4B;

FIG. 5A is a cross-sectional view of the card edge connector of FIG. 2A taken along line A-A in FIG. 2C;

FIG. 5B is a cross-sectional view of the card edge connector of FIG. 2A taken along line B-B in FIG. 2C;

FIG. 5C is a cross-sectional view of the card edge connector of FIG. 2A taken along line C-C in FIG. 2C;

FIG. 5D is a cross-sectional view of the card edge connector of FIG. 2A taken along line D-D in FIG. 2C;

FIG. 6A is a top, side perspective view of the first shielding member of FIG. 3;

FIG. 6B is a bottom, side perspective view of the first shielding member of FIG. 6A;

FIG. 7A is a top, side perspective view of a set of three conductive terminals in the first middle zone of FIG. 4A;

FIG. 7B is a bottom, side perspective view of the set of three conductive terminals of FIG. 7A;

FIG. 7C is a side elevation view of the set of three conductive terminals of FIG. 7A; and

FIG. 8 is a front elevation view of a portion of a card edge connector, illustrating zones of the two terminal rows configured for transmitting differential signals, according to some embodiments.

LIST OF REFERENCE NUMERALS

| | |
|---|---|
| 1 | electronic system |
| 3 | first circuit board |
| 5 | second circuit board |
| 7 | edge portion of the first circuit board |
| 9 | first conductive portion |
| 11 | edge portion of the second circuit board |
| 13 | second conductive portion |
| 100 | card edge connector |
| 101 | insulative housing |
| 103 | base portion |
| 103 a | first side |
| 103 b | second side |
| 104 | rib |
| 105 | longitudinal direction |
| 107 | socket |
| 107 a | first socket section |
| 107 b | second socket section |
| 109 | mating direction |
| 111 a | first receiving portion |
| 111 b | second receiver portion |
| 200 a | first terminal row |
| 200 b | second terminal row |
| 201 | first contact portion |
| 202 | second contact portion |
| 203 | intermediate portion |
| 203 a | first section |
| 203 b | second section |
| 203 c | third section |
| 301 | first shielding member |
| 302 | second shielding member |
| 303 | third shield member |
| 2001 | first ground terminal |
| 2003 | first signal terminal |
| 3011 | first connection portion |
| 3013 | first body |
| 3015 | first extension |
| 3017 | second extension |
| 3019 | protruding feature |
| 3021 | cutout |
| 3031 | protrusion |

### DETAILED DESCRIPTION

The Inventors have recognized and appreciated connector design techniques that satisfy electrical and mechanical requirements to support greater bandwidth through high frequency operation. Some of these techniques may synergistically support higher frequency connector operation and satisfy the physical requirements set by industry standards such as Peripheral Component Interconnect Express (PCIe). A straddle mount connector satisfying the mechanical requirements of the PCIe specification at the performance required for PCIe 5.0 and beyond is used as an example of a connector in which these techniques have been applied.

A straddle mount connector may be designed to hang over an edge of a printed-circuit board, which may be referred to as “host board,” rather than sitting on one side of the board. The straddle mount connector may include shielding members shaped and disposed to increase signal integrity without changing the size of the connector. The shielding members may extend substantially along the length of the terminals and therefore enable the connector to provide increased signal integrity.

A shielding member may be disposed outside a row of terminals. The shielding member may extend from a contact region for an add-in card to a contact region for the host card. Portions of the shielding member may extend beyond the connector housing so as to lengthen the shielding provided along the lengths of the terminals. The portions of the shielding member may be configured to interact with the terminals to provide a desired impedance uniformity along the current conduction paths. The shielding member may include contact portions curving toward the row of terminals and electrically coupled to the ground terminals in the row. The connector housing may be molded with features to hold the shield members in place.

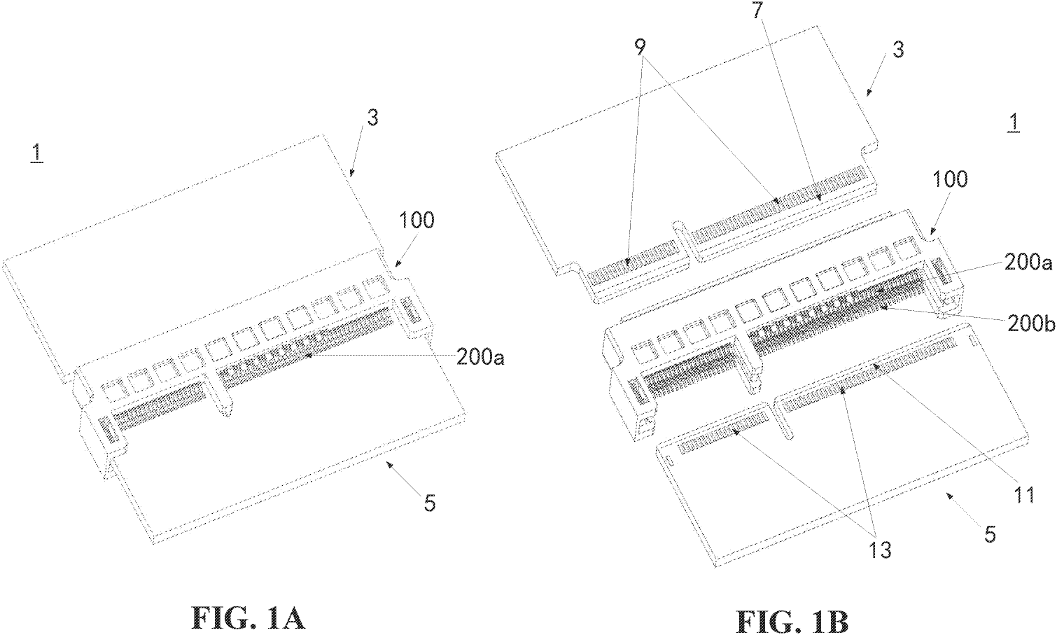

FIGS. 1A and 1B schematically illustrate an electronic system 1 including a card edge connector 100 according to some embodiments . As shown in FIGS. 1A and 1B, the electronic system 1 includes a first circuit board 3 (such as a daughter card or add-in card), a second circuit board 5 (such as a mother board or host board), and a card edge connector 100 configured for establishing an electrical connection between the first circuit board 3 and the second circuit board 5. The first circuit board 3 has a first conductive portion 9 on or near an edge portion 7 thereof. The first conductive portion 9 is, for example, a conductive trace or pad on the first circuit board 3. The second circuit board 5 has a second conductive portion 13 on or near an edge portion 11 thereof. The second conductive portion 13 is, for example, a conductive trace or pad on the second circuit board 5. The conductive terminals (which are indicated in FIGS. 1A and 1B with a first terminal row 200a and a second terminal row 200b and will be described in detail below) of the card edge connector 100 may electrically interconnect the first conductive portion 9 and the second conductive portion 13 via the conductive terminals by establishing an electrical connection with the first conductive portion 9 and the second conductive portion 13, respectively, thereby establishing an electrical connection between the first circuit board 3 and the second circuit board 5. This enables signal transmission and optionally power transmission between the first circuit board 3 and the second circuit board 5.

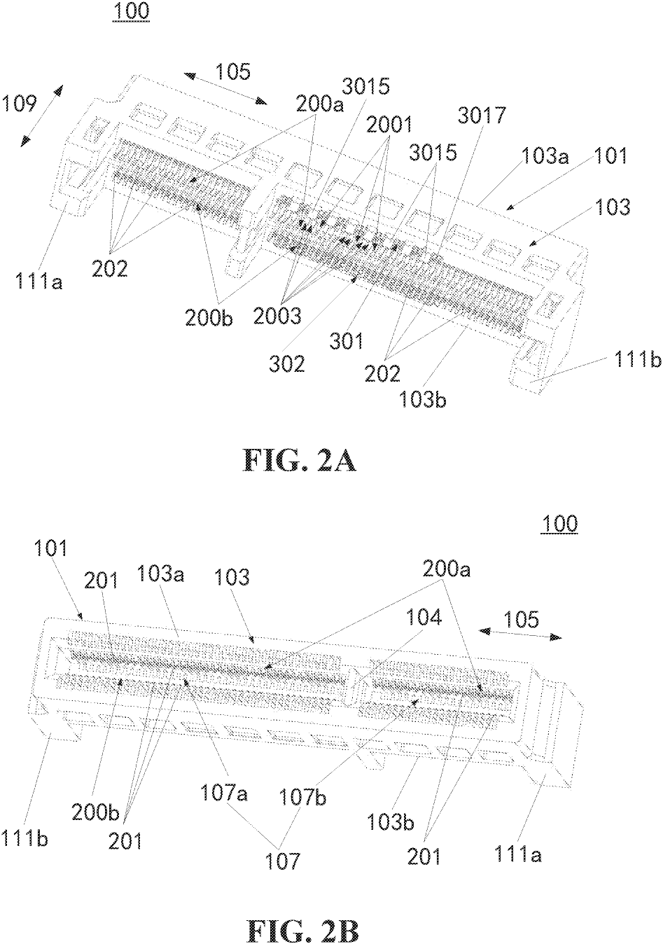

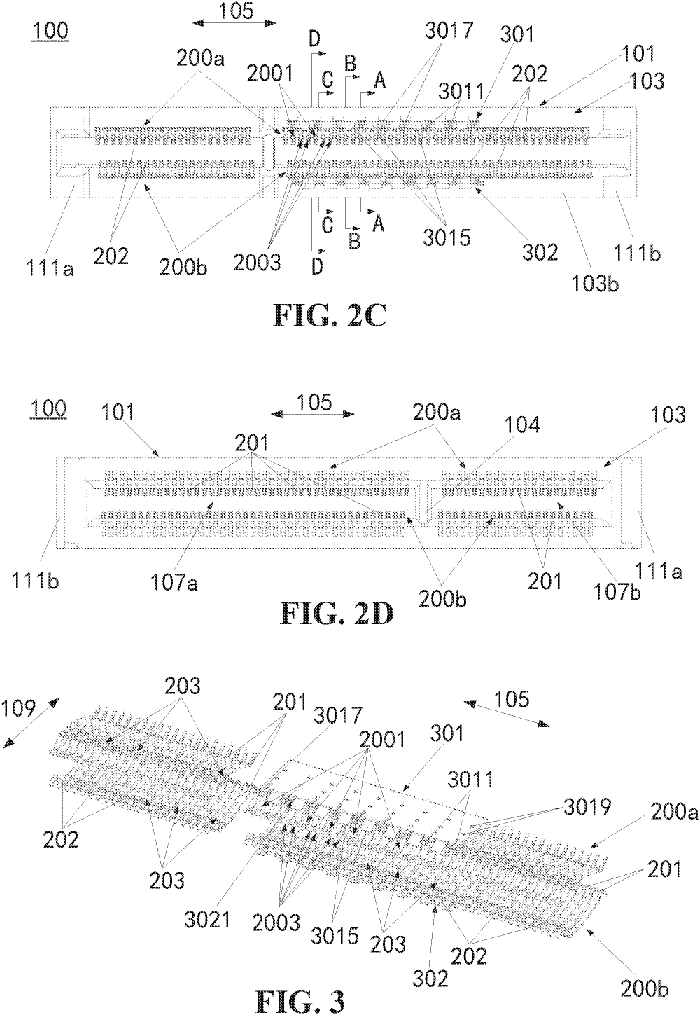

FIGS. 2A to 2D schematically illustrate the card edge connector 100. The card edge connector 100 includes an insulative housing 101, a plurality of conductive terminals held in the insulative housing 101, and a first shielding member 301 and a second shielding member 302 held in the insulative housing 101. The insulative housing 101 includes a base portion 103 extending along a longitudinal direction 105, and a socket 107 recessed into the base portion 103 along a mating direction 109 perpendicular to the longitudinal direction 105 from a first side 103a of the base portion 103. Examples of insulative materials that are suitable for forming the insulative housing 101 include, but are not limited to, plastic, nylon, liquid crystal polymer (LCP), polyphenyline sulfide (PPS), high temperature nylon or polyphenylenoxide (PPO) or polypropylene (PP).

The socket 107 is configured for receiving the edge portion 7 of the first circuit board 3. The socket 107 is shown in FIGS. 2B and 2D as having two socket sections, i.e., a first socket section 107a and a second socket section 107b. The first socket section 107a and the second socket section 107b are spaced apart by a rib 104 formed from the base portion 103. The second socket section 107b may receive another section of the edge portion 7 of the first circuit board 3 different from the section received by the first socket section 107a. The first socket section 107a and the second socket section 107b may have different lengths along the longitudinal direction 105, and/or the first socket section 107a and the second socket section 107b may have different depths along the mating direction 109. This may provide a dummy-proof function to prevent intentional or unintentional operational errors. It should be appreciated that the socket 107 may include any other numbers of socket sections, such as one socket section or more than two socket sections.

FIG. 3 schematically illustrates a configuration, an arrangement and a fitting manner of the plurality of conductive terminals, the first shielding member 301 and the second shielding member 302 of the card edge connector 100. As compared to FIG. 2A, in FIG. 3, the insulative housing 101 of the card edge connector 100 is removed to show an arrangement and a fitting manner of the plurality of conductive terminals, the first shielding member 301 and the second shielding member 302 in the card edge connector 100. In other words, the arrangement and the fitting manner of the plurality of conductive terminals, the first shielding member 301 and the second shielding member 302 shown in FIG. 3 are the arrangement and the fitting manner of the plurality of conductive terminals, the first shielding member 301 and the second shielding member 302 in the card edge connector 100.

As shown in FIG. 3, each of the plurality of conductive terminals includes a first contact portion 201, a second contact portion 202 opposite to the first contact portion 201, and an intermediate portion 203 extending between the first contact portion 201 and the second contact portion 202. Each of the plurality of conductive terminals is formed from a conductive material. The conductive material suitable for forming the plurality of conductive terminals may be a metal (such as a copper) or a metal alloy (such as a copper alloy). As described above, the plurality of conductive terminals are held in the insulative housing 101. In particular, as shown in FIGS. 2A to 2D and 3, the plurality of conductive terminals are arranged in a first terminal row 200a and a second terminal row 200b extending along the longitudinal direction 105 respectively, mutually opposed and spaced apart, with the first contact portion 201 exposed in the socket 107 for establishing an electrical connection with a first conductive portion 9 of the first circuit board 3 when the first circuit board 3 is inserted into the socket 107, and with the second contact portion 202 protruding from a second side 103b of the base portion 103 opposite to the first side 103a for establishing an electrical connection with the second conductive portion 13 of the second circuit board 5.

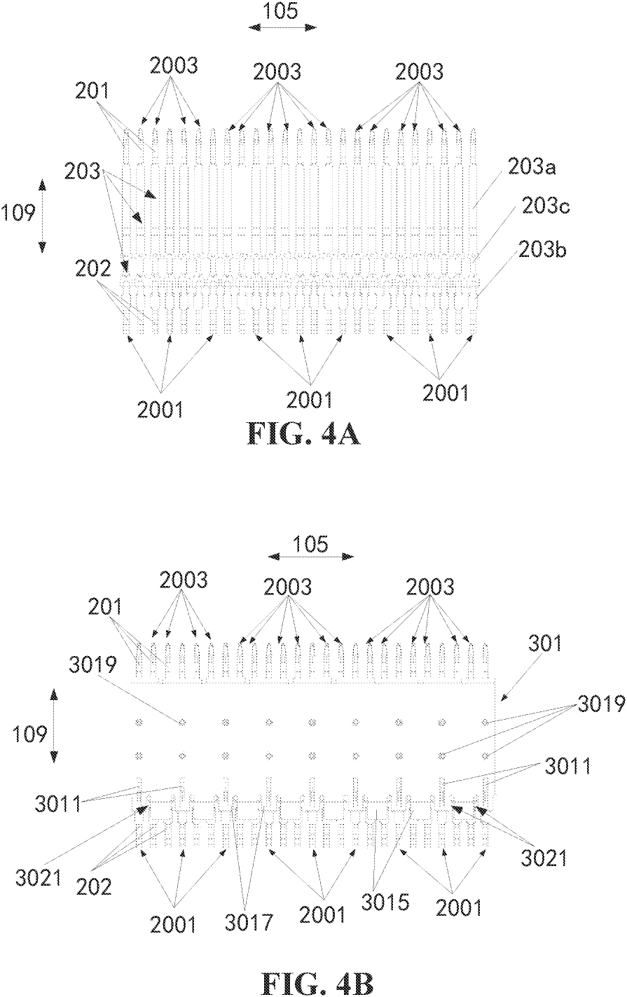

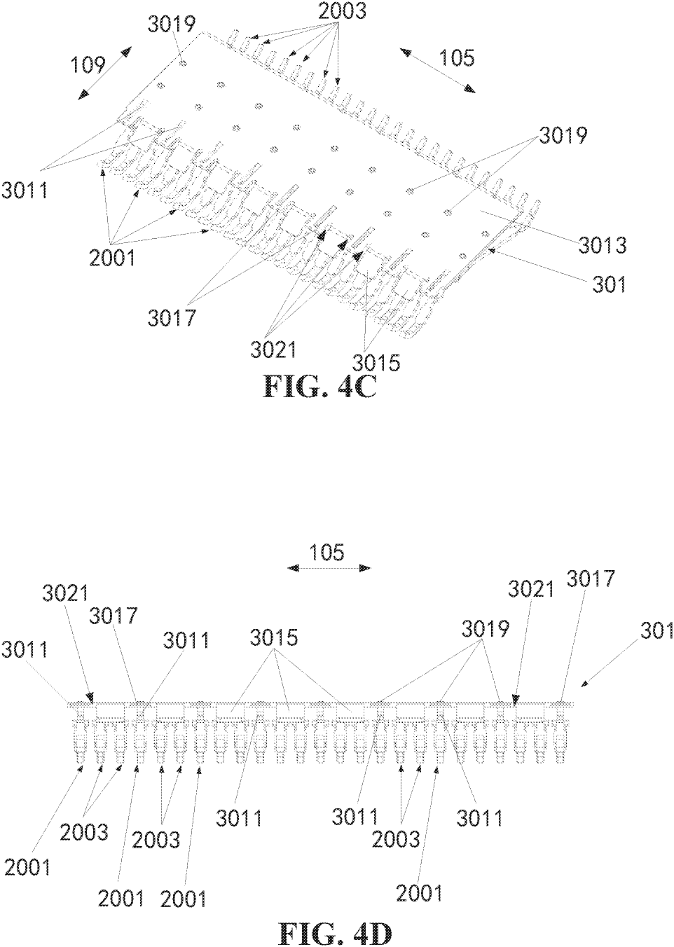

With continuing reference to FIGS. 2A to 2D and 3, the first terminal row 200a includes a plurality of first ground terminals 2001 and a plurality of pairs of first signal terminals 2003. The plurality of first ground terminals 2001 and the plurality of pairs of first signal terminals 2003 may constitute a zone of the first terminal row 200a as shown in FIG. 4A. The zone may be used to transmit high frequency signal. Each pair of the plurality of pairs of first signal terminals 2003 may be configured as a differential signal pair for carrying differential signal. For example, a signal terminal of each pair of first signal terminals 2003 may be energized by a first voltage, and the other signal terminal may be energized by a second voltage. The voltage difference between two signal terminals of each pair of first signal terminals 2003 may represent a signal. A plurality of first ground terminals 2001 may be arranged adjacent to each pair of first signal terminals 2003 to separate the plurality of pairs of first signal terminals 2003 from each other to reduce a crosstalk between the signals, thereby improving signal integrity. As shown in FIG. 4A, the plurality of first ground terminals 2001 and the plurality of pairs of first signal terminals 2003 are arranged in a “G-S-S-G-S-S......G-S-S-G″ pattern (where G represents the first ground terminal 2001 and S represents the first signal terminal 2003), with a first ground terminal 2001 disposed between every two adjacent pairs of first signal terminals 2003, such that every two adjacent pairs of first signal terminals 2003 can share the first ground terminal 2001.

In some examples, as shown in FIGS. 2A, 2C, and 3, the total number of first signal terminals 2003 and first ground terminals 2001 is less than the total number of conductive terminals in the first terminal row 200a. As described above, the plurality of first ground terminals 2001 and the plurality of pairs of first signal terminals 2003 may constitute a zone of the first terminal row 200a. As shown in FIG. 4A, two of the plurality of first ground terminals 2001 may be arranged at opposite ends of the zone along the longitudinal direction 105, respectively. The first terminal row 200a may also include signal terminals and/or power terminals arranged on each side of the zone in the first terminal row 200a. It should be appreciated that the first terminal row 200a may be in any suitable forms. For example, the total number of first signal terminals 2003 and first ground terminals 2001 may be equal to the total number of conductive terminals in the first terminal row 200a, or the first terminal row 200a may include more than one of the aforementioned zones.

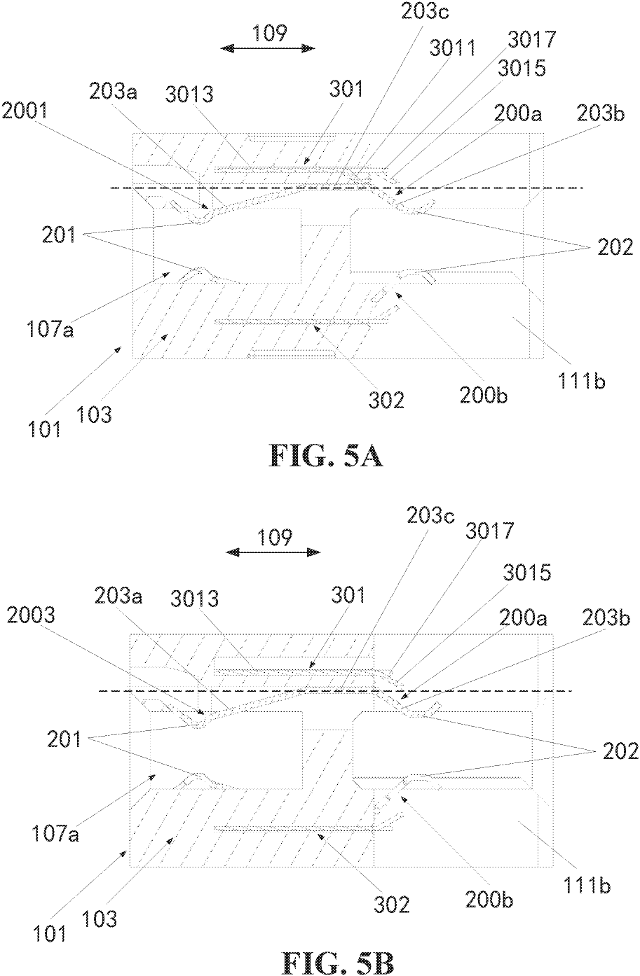

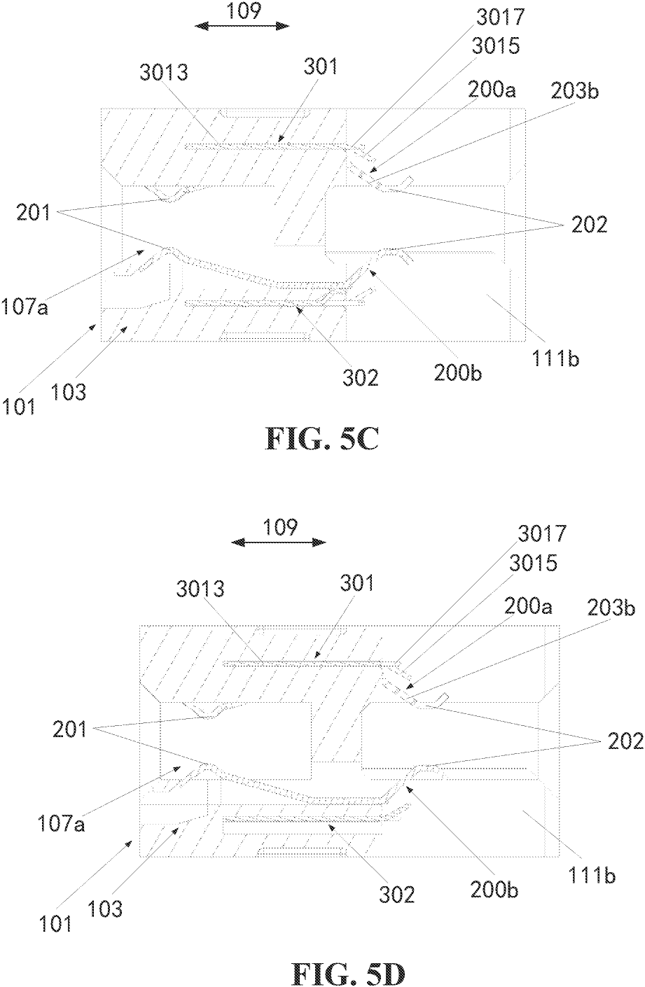

With further reference to FIGS. 2A, 2C and 3, the first shielding member 301 may be held in the base portion 103 on a side of the first terminal row 200a facing away from the second terminal row 200 and spaced apart from the first terminal row 200a. The first shielding member 301 may be formed from a conductive or partially conductive material. The material suitable for forming the first shielding member 301 may be, but not limited to, a metal (e.g., copper) or a metal alloy (e.g., copper alloy). As shown in FIG. 3, and further as shown in FIGS. 4B to 4D and 5A to 5D, the first shielding member 301 may be configured for covering at least the intermediate portion 203 of the plurality of pairs of first signal terminals 2003 in the first terminal row 200a along substantially their widths in the longitudinal direction 105 and their lengths in the mating direction 109, and for electrically connecting the plurality of first ground terminals 2001 together.

The Inventors have recognized and appreciated that electrically connecting the plurality of first ground terminals 2001 together through the first shielding member 301 may provide a conductive path among the plurality of first ground terminals 2001 , which may reduce electrical potential differences between the plurality of first ground terminals 2001, and may control and/or suppress undesired resonances that may occur within the first ground terminal 2001 during the operation of the card edge connector 100 and therefore shift the resonance point of the crosstalk toward higher frequencies. The Inventors have recognized and appreciated that the first shielding member 301 covering the intermediate portions 203 of the plurality of pairs of first signal terminals 2003 in the longitudinal direction 105 and the mating direction 109 may provide shielding along the differential signal transmission path in the card edge connector 100. This enables to improve integrity of the signal passing through the card edge connector 100, thereby improving the high frequency transmission performance of the card edge connector 100. The use of the first shielding member 301 to connect the plurality of first ground terminals 2001 may improve the high frequency transmission performance of the card edge connector 100 without increasing the size of the insulative housing 101, thereby facilitating miniaturization of the card edge connector 100.

It should be appreciated that, as used herein, the first shielding member 301 covering the intermediate portions 203 of the plurality of pairs of first signal terminals 2003 in the longitudinal direction 105 may refer to that the first shielding member 301 extends in the longitudinal direction 105 to cover more than 90% (e.g., 95%, 98%, or 100%) of the length of the intermediate portion 203 of each first signal terminal 2003 of the plurality of pairs of first signal terminals 2003. It should also be appreciated that, as used herein, the first shielding member 301 covering the intermediate portions 203 of the plurality of pairs of first signal terminals 2003 in the mating direction 109 may refer to that the first shielding member 301 extends in the mating direction 109 to cover the intermediate portions 203 of all of the first signal terminals 2003 of the plurality of pairs of first signal terminals 2003.

In some examples, the first shielding member 301 may be a wave plate or a porous plate. In some other examples, as will be described below, the body of the first shielding member 301 may be continuously flat in the longitudinal direction 105 and the mating direction 109.

With reference to FIGS. 2C, 4B to 4D, 5A, 5C, 6A and 6B, the first shielding member 301 may include a plurality of first connection portions 3011, each of the plurality of first connection portions 3011 may extend from the body of the first shielding member 301 towards a corresponding one of the plurality of first ground terminals 2001 and is electrically connected to the corresponding one first ground terminal 2001 at the intermediate portions 203 of the corresponding one first ground terminal 2001, thereby electrically connecting the corresponding one first ground terminal 2001 to the first shielding member 301. In some embodiments, as shown in FIGS. 2C, 4B to 4D, 5A, 5C, 6A and 6B, each of the plurality of first connection portions 3011 may be a spring arm punched integrally from the first shielding member 301, with the spring arm abutting against the intermediate portion 203 of the corresponding one first ground terminal 2001. This spring arm configuration enables that a reliable electrical connection is maintained between the first ground terminal 2001 and the first shielding member 301. In some embodiments, each of the plurality of first connection portions 3011 may be a protrusion protruding from the first shielding member 301 towards the corresponding one first ground terminal 2001, or may be in any other suitable forms.

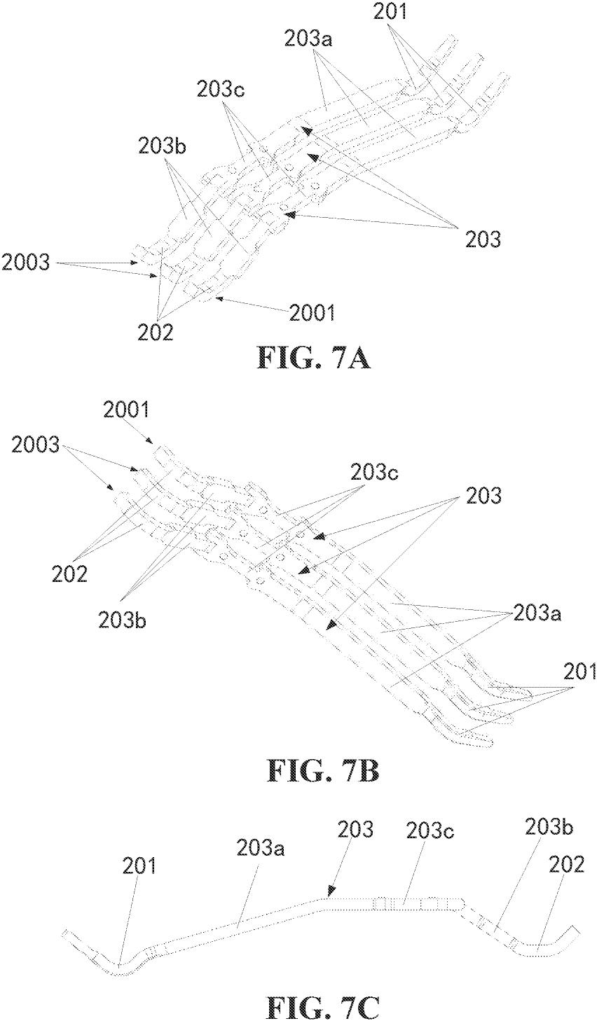

FIGS. 7A to 7C schematically illustrate a set of three adjacent conductive terminals in the zone shown in FIG. 4A. The three conductive terminals may include a first ground terminal 2001 and a pair of first signal terminals 2003 constituting a differential signal pair. The first signal terminals 2003 and the first ground terminal 2001 have the same configurations, as shown in FIGS. 7A to 7C. Each of the intermediate portion 203 of the first ground terminal 2001 and the intermediate portion 203 of the first signal terminal 2003 may include a first section 203a connected with the first contact portion 201, a second section 203b connected with the second contact portion 202, and a third section 203c connecting the first section 203a with the second section 203b. When the first ground terminal 2001 and the first signal terminals 2003 are arranged in the card edge connector 100, the third sections 203c extend parallelly to the mating direction 109. It should be appreciated that the first ground terminals 2001 and the first signal terminals 2003, which constitute the zone of the first terminal row 200a, have substantially the same configurations, however, the present disclosure is not limited thereto. The first connection section 3011 may be connected to the corresponding one first ground terminal 2001 on the third section 203c of the intermediate portion 203 of the corresponding one first ground terminal 2001. In this way, a reliable electrical connection may be maintained between the first ground terminals 2001 and the first shielding member 301. In some examples, as shown in FIGS. 5A and 5C, the position where the first connection section 3011 is connected to the third section 203c of the intermediate portion 203 of the corresponding first ground terminal 2001 is closer to the second section 203b, rather than to the first section 203a.

As shown in FIGS. 2A to 5B, the first signal terminals 2003 of the plurality of pairs of first signal terminals 2003 and the first ground terminals 2001 of the plurality of first ground terminals 2001 in the first terminal row 200a may be aligned along the longitudinal direction 105. The third section 203c of the intermediate portion 203 of each first ground terminal 2001 of the plurality of first ground terminals 2001 and the third section 203c of the intermediate portion 203 of each first signal terminal 2003 of the plurality of first signal terminals 2003 may collectively define a first plane. In other words, the third section 203c of the intermediate portion 203 of each first ground terminal 2001 of the plurality of first ground terminals 2001 and the third section 203c of the intermediate portion 203 of each first signal terminal 2003 of the plurality of pairs of first signal terminals 2003 may be co-planar in the first plane (as indicated by the dashed lines in FIGS. 5A and 5B). The second section 203b of the intermediate portion 203 of each first ground terminal 2001 of the plurality of first ground terminals 2001 and the second section 203b of the intermediate portion of each first signal terminal 2003 of the plurality of pairs of first signal terminals 2003 may extend obliquely away from the first plane, respectively. In some examples, as shown in FIGS. 2A to 5B and 7A to 7C, the second section 203b of the intermediate portion 203 of each first ground terminal 2001 of the plurality of first ground terminals 2001 and the second section 203b of the intermediate portion 203 of each first signal terminal 2003 of the plurality of pairs of first signal terminals 2003 may extend obliquely away from the first plane towards the second terminal row 200b, respectively. It should be appreciated that in some embodiments, the second section 203b of the intermediate portion 203 of each first ground terminal 2001 of the plurality of first ground terminals 2001 and the second section 203b of the intermediate portion 203 of each first signal terminal 2003 of the plurality of pairs of first signal terminals 2003 may extend obliquely away from the first plane and away from the second terminal row 200b.

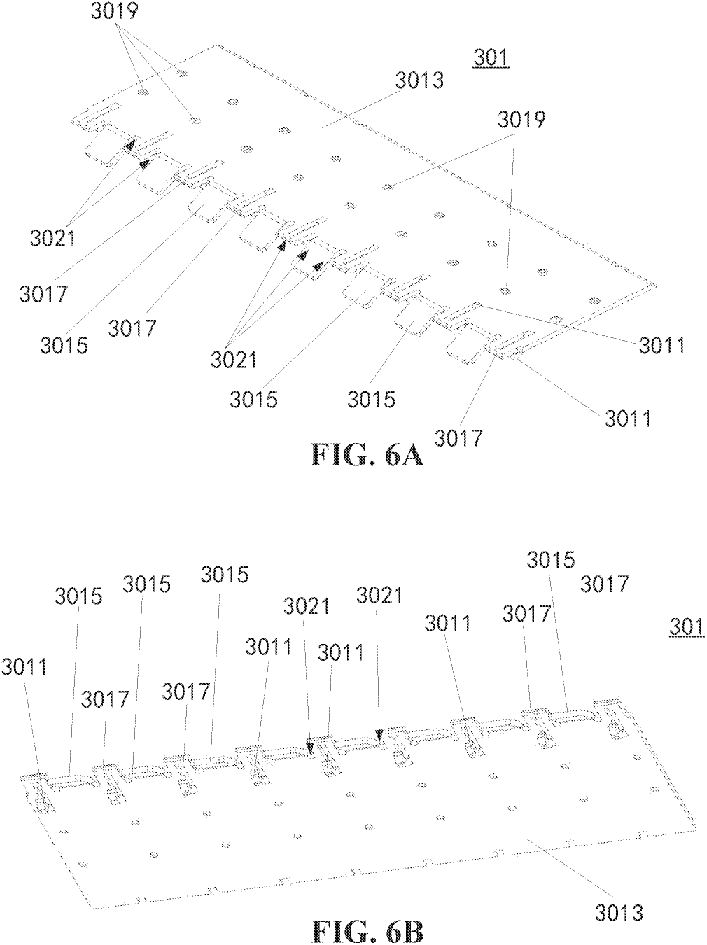

FIGS. 6A and 6B illustrate the first shielding member 301, according to some embodiments. As shown in FIGS. 6A and 6B, the first shielding member 301 includes a first body 3013 and a plurality of first extensions 3015 extending from the first body 3013. The plurality of first extensions 3015 may be punched integrally together with the first body 3013 during manufacture of the first shielding member 301 in some embodiments, or by any other suitable manufacturing processes such as cutting in some embodiments. As shown in FIGS. 2A, 2C, 3, 4C to 4D, and 5A to 5D, the first body 3013 may extend substantially parallelly to the aforementioned first plane, which may be collectively defined by the third section 203c of the intermediate portion 203 of each first ground terminal 2001 of the plurality of first ground terminals 2001 and the third section 203c of the intermediate portion 203 of each first signal terminal 2003 of the plurality of pairs of first signal terminals 2003. The first body 3013 may cover the first sections 203a and the third sections 203c of the intermediate portions 203 of the plurality of pairs of first signal terminals 2003 and the first sections 203a and the third sections 203c of the intermediate portions 203 of the plurality of first ground terminals 2001 in the longitudinal direction 105 and the mating direction 109. As illustrated in FIGS. 2A, 3, 4B, 4C, and 5B, each of the plurality of first extensions 3015 may extend along and parallelly to the second sections 203b of the two intermediate portions 203 of a corresponding pair of first signal terminals 2003 of the plurality of pairs of first signal terminals 2003. In this way, it is possible to provide shielding substantially along the entire length of the differential signal transmission path in the card edge connector 100. This enables to improve the integrity of signal passing through the card edge connector 100, thereby improving the high frequency transmission performance of the card edge connector 100.

In some embodiments, as shown in FIGS. 5A to 5D, the third sections 203c of the intermediate portions 203 of the plurality of pairs of first signal terminals 2003 and the third sections 203c of the intermediate portions 203 of the plurality of first ground terminals 2001 may be retained by the base portion 103 of the insulative housing 101. The second sections 203b of the intermediate portions 203 of the plurality of pairs of first signal terminals 2003 and the second sections 203b of the intermediate portions 203 of the plurality of ground terminals 2001 may protrude out of the second side 103b of the base portion 103. The first body 3013 of the first shielding member 301 may be retained in the base portion 103 of the insulative housing 101. The plurality of first extensions 3015 may extend out of the second side 103b of the base portion 103. Each of the plurality of first extensions 3015 may extend along and parallelly to the second sections 203b of the two intermediate portions 203 of a corresponding pair of the plurality of pairs of first signal terminals 2003 to provide shielding substantially along the entire length of the differential signal transmission path in the card edge connector 100.

In some embodiments, as shown in FIGS. 6A and 6B, the first shielding member 301 may include a plurality of second extensions 3017 extending from the first body 3013. The plurality of second extensions 3017 may separate the plurality of first extensions 3015 from each other, with a second extension 3017 disposed between every two adjacent first extensions 3015. Each of the plurality of second extensions 3017 may be spaced from the two adjacent first extensions 3015 by a cutout 3021 cut into the first body 3013. In the illustrated example, each of the plurality of first connection portions 3011 is a spring arm extending from the first shielding member 301, each of the plurality of first connection portions 3011 is at least partially punched integrally from a corresponding second extension portion 3017 of the plurality of second extension portions 3017.

The first shielding member 301 may further include a first retention feature configured for retaining the first shielding member 301 in the base portion 103. In some embodiments, as shown in FIGS. 3 and 6A, the first retention feature of the first shielding member 301 may include a protruding feature 3019 protruding from the first shielding member 301 beyond a surface of the first shielding member 301 facing away from the first terminal row 200a. In the illustrated example, each of the plurality of first connection portions 3011 is a spring arm extending from the first shielding member 301, the protruding feature 3019 may form an interference fit with an inner wall of a chamber of the base portion 103 for receiving the first shielding member 301 under a spring force from the spring arm, thereby securely retaining the first shielding member 301 in the base portion 103. The protruding feature 3019 may be, for example, a bump formed by a pressing operation.

The configuration, the arrangement and the fitting manner of the plurality of first ground terminals 2001, the plurality of pairs of first signal terminals 2003 and the first shielding member 301 in the first terminal row 200a of the card edge connector 100 are described above in connection with FIGS. 2A to 7C. The second terminal row 200b of the card edge connector 100 may include a plurality of second ground terminals and a plurality of pairs of second signal terminals (not indicated in the drawings). The plurality of second ground terminals and the plurality of pairs of second signal terminals in the second terminal row 200b of the card edge connector 100 may have the same or substantially the same configurations and arrangements as the plurality of first ground terminals 2001 and the plurality of pairs of first signal terminals 2003 in the first terminal row 200a, and the second shielding member 302 may also fit with the plurality of second ground terminals and the plurality of pairs of second signal terminals in the same or substantially the same manners as described above in connection with the first shielding member 301 so as to provide the benefits described above. In some embodiments, the plurality of second ground terminals and the plurality of pairs of second signal terminals in the second terminal row 200b may be arranged opposite to the plurality of first ground terminals 2001 and the plurality of pairs of first signal terminals 2003 in the first terminal row 200a, as shown in FIGS. 2A, 2C, and 3. For example, the number of the first signal terminals 2003 in the first terminal row 200a may be the same as that of the second signal terminals in the second terminal row 200b, and the number of the first ground terminals 2001 in the first terminal row 200a may be the same as that of the second ground terminals in the second terminal row 200b. The plurality of first ground terminals 2001 and the plurality of pairs of first signal terminals 2003 may be spaced apart from the plurality of second ground terminals and the plurality of pairs of second signal terminals. The first ground terminals 2001 and the pairs of first signal terminals 2003 may be disposed on an opposite side of the socket 107 to the second ground terminals and the pairs of second signal terminals. offset from each other. This facilitates miniaturization of the card edge connector 100.

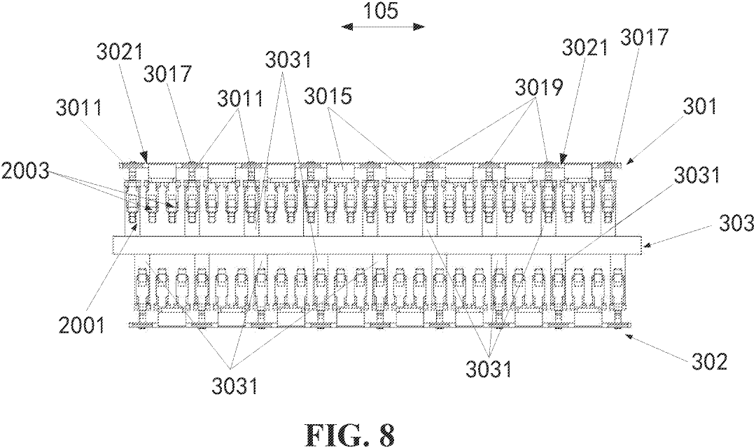

FIG. 8 schematically shows a card edge connector according to some embodiments, which may be substantially the same as the card edge connector 100 shown in FIGS. 2A to 7C. Thus, only a partial view of the card edge connector is provided to show the difference, and the same or similar parts and sections are indicated with the same reference numbers. The card edge connector shown in FIG. 8 differs from the card edge connector 100 shown in FIGS. 2A to 7C in that the card edge connector shown in FIG. 8 further includes a third shield member 303 disposed in the base portion 103 of the insulative housing 101 between the first terminal row 200a and the second terminal row 200b. The third shield member 303 may be configured for electrically coupling the plurality of first ground terminals 2001 in the first terminal row 200a and the plurality of second ground terminals in the second terminal row 200b together.

As shown in FIG. 8, the third shield member 303 may include a plurality of protrusions 3031 extending towards the plurality of first ground terminals 2001 in the first terminal row 200a and the plurality of second ground terminals in the second terminal row 200b. Each of the plurality of first ground terminals 2001 and the plurality of second ground terminals is electrically coupled to the third shield member 303 through the protrusions 303. In this way, the plurality of first ground terminals 2001, the plurality of second ground terminals, the first shielding member 301, and the second shielding member 302 are electrically coupled together, allowing for further improvement in integrity of the signal passing through the card edge connector 100, thereby further improving the high frequency transmission performance of the card edge connector 100. As shown in FIG. 8, the third shield member 303 is electrically coupled to a corresponding ground terminal at the intermediate portion 203 of each of the plurality of first ground terminals 2001 and the plurality of second ground terminals.

In some embodiments, the third shield member 303 may be made of metal and electrically couples the plurality of first ground terminals 2001 and the plurality of second ground terminals together.

In some embodiments, the third shield member 303 may be formed from a lossy material. The third shield member 303 may be capacitively coupled or in direct contact with the plurality of first ground terminals 2001 and the plurality of second ground terminals. This enables to reduce the effect of electrical resonance, thereby improving signal integrity. When the electrical resonance occurs at a frequency within the operating frequency range of the card edge connector 100, the integrity of the high-speed signal passing through the card edge connector 100 may deteriorate. The deterioration in the integrity of the signal passing through the card edge connector 100 may be partially caused by the loss of signal energy coupled into the resonant signal, which means that less signal energy passes through the card edge connector 100. The deterioration in the integrity of the signal passing through the card edge connector 100 may be partially caused by the coupling of the resonant signal from the ground terminals to the signal terminals. The resonant signal accumulates and possesses a high amplitude, so that when the resonant signal is coupled from the ground terminals to the signal terminals, it will generate a large amount of noise that interferes with the signal. Sometimes, the resonant signal coupled to the signal terminals may be referred to as crosstalk. The frequency at which electrical resonance occurs is related to the length of the ground terminals supporting the electrical resonance, since the wavelength of the resonant signal is related to the length of the ground terminals supporting the resonance, and the frequency is inversely related to the wavelength. Electrically coupling the third shield member 303 formed from a lossy material to the ground terminals may enable energy coupled into the ground terminals and accumulated into a resonant signal to be dissipated in the third shield member 303, which makes the occurrence of electrical resonance less likely, thereby increasing signal integrity and improving the operating frequency range of the card edge connector 100.

The card edge connector 100 shown in FIGS. 2A to 2D may be a straddle mount connector and includes a first receiving portion 111a and a second receiving portion 111b extending from the second side 103b of the base portion 103 at each end of the base portion 103 along the longitudinal direction 105, respectively. The first receiving portion 111a and the second receiving portion 111b may be configured for guiding, receiving and retaining the edge portion 11 of the second circuit board 5. When the edge portion 11 of the second circuit board 5 is received in the first receiving portion 111a and the second receiving portion 111b, a portion of the second circuit board 5 provided with the second conductive portion 13 (i.e., the edge portion 11) may be disposed between the second contact portions 202 of the first terminal row 200a and the second terminal row 200b, and the second contact portions 202 may establish an electrical connection with the second conductive portion 13. In some embodiments, the second contact portions 202 may be a pin suitable for surface mounting and may subsequently be secured to the second conductive portion 13 by welding.

It should be appreciated that the fitting manner between the first shielding member, the second shield, the conductive terminal and the third shield member described therein may be used in any other suitable types of connectors, such as a right angle connector or a vertical connector.

It should also be appreciated that, the card edge connector 100 may include only the aforementioned first shielding member 301 or the aforementioned second shielding member 302 in some embodiments, or both in some embodiments. In some embodiments, the card edge connector 100 may optionally include the aforementioned third shield member 303.

It should also be appreciated that the terms “first”, “second”, “third”, “fourth”, “fifth” and “sixth” are only used to distinguish an element or component from another element or component, and that these elements and/or components should not be limited by the terms.

The present disclosure has been described in detail in conjunction with specific embodiments. Obviously, the above description and the embodiments shown in the appended drawings should be understood to be exemplary and do not constitute a limitation to the present disclosure. For a person skilled in the art, various variations or modifications can be made without departing from the spirit of the present disclosure, and these variations or modifications fall within the scope of the present disclosure.

What is claimed is:

1. A card edge connector, comprising:
a housing comprising a base portion extending in a longitudinal direction and a socket recessed into the base portion in a mating direction perpendicular to the longitudinal direction;
a plurality of conductive terminals held in the housing and disposed in a row extending in the longitudinal direction, the plurality of conductive terminals each comprising a first contact portion curving into the socket, a second contact portion opposite the first contact portion and disposed outside the base portion, and an intermediate portion extending between the first contact portion and the second contact portion, the plurality of conductive terminals comprising a plurality of pairs of signal terminals and a plurality of ground terminals between the pairs; and
a shielding member at least partially held in the base portion and separated from the socket by the plurality of conductive terminals, the shielding member configured to overlap at least the intermediate portions of the plurality of pairs of signal terminals and to electrically connect the plurality of ground terminals.

2. The card edge connector of claim 1, wherein the shielding member comprises
a body, and
a plurality of connection portions extending from the body and towards respective ones of the plurality of ground terminals.

3. The card edge connector of claim 2, wherein:
each intermediate portion of the plurality of ground terminals and the plurality of pairs of signal terminals comprises a first section joining the first contact portion, a second section joining the second contact portion, and a third section joining the first section and the second section, and
the plurality of connection portions are connected to the plurality of ground terminals at the third sections of the intermediate portions.

4. The card edge connector of claim 3, wherein:
contact points between the plurality of connection portions of the shielding member and the plurality of ground terminals are closer to the second section than the first section.

5. The card edge connector of claim 3, wherein:
the third sections of the intermediate portions of the plurality of ground terminals and the plurality of pairs of signal terminals extend in a first plane, and
the second sections of the intermediate portions of each of the plurality of ground terminals and the plurality of pairs of signal terminals extend in an angle with respect to the first plane.

6. The card edge connector of claim 5, wherein:
the body of the shielding member extends in parallel to the first plane,
the body overlaps the first and third sections of the intermediate portions of the plurality of pairs of signal terminals and the plurality of ground terminals,
the shielding member comprises a plurality of extensions extending from the body and each extending in parallel to the second sections of the intermediate portions of one pair of the plurality of pairs of signal terminals.

7. The card edge connector of claim 6, wherein:
the third sections of the intermediate portions of the plurality of pairs of signal terminals and the plurality of ground terminals are retained by the base portion,
the second sections of the intermediate portions of the plurality of pairs of signal terminals and the plurality of ground terminals extend out of the base portion,
the body of the shielding member is retained in the base portion, and
the plurality of extensions extend out of the base portion.

8. The card edge connector of claim 7, wherein:
the plurality of extensions are a plurality of first extensions,
the shielding member comprises a plurality of second extensions extending from the body,
the plurality of first extensions are separated from each other by the plurality of second extensions, with one second extension between every two adjacent first extensions, and
each of the plurality of second extensions is spaced apart from two adjacent first extensions by a cutout extending into the body and disposed corresponding to one of the plurality of ground terminals.

9. The card edge connector of claim 1, further comprising:
one or more signal terminals and/or power terminals disposed in the row.

10. A card edge connector, comprising:
a housing comprising a base portion extending in a longitudinal direction and a socket recessed into the base portion in a mating direction perpendicular to the longitudinal direction;
a plurality of conductive elements held in the housing and disposed in a row extending in the longitudinal direction, the plurality of conductive terminals each comprising a first contact portion curving into the socket, a second contact portion opposite the first contact portion and disposed outside the base portion, and an intermediate portion joining the first contact portion and the second contact portion; and
a shielding member comprising:
a body at least partially held in the base portion; and
a plurality of extensions extending from and transverse to the body and out of the base portion and closer to the second contact portions of the plurality of conductive elements.

11. The card edge connector of claim 10, wherein:
the plurality of conductive elements are a first plurality of conductive elements disposed in a first row,
the shielding member is a first shielding member,
the card edge connector comprises:
a second plurality of conductive elements held in the housing and disposed in a second row in the longitudinal direction and separated from the first row by the socket, the second plurality of conductive terminals each comprising a first contact portion curving into the socket, a second contact portion opposite the first contact portion and disposed outside the base portion, and an intermediate portion joining the first contact portion and the second contact portion, the second plurality of conductive terminals comprising a plurality of pairs of signal terminals and a plurality of ground terminals dispersed between the pairs; and
a second shielding member held in the base portion and separated from the socket by the second plurality of conductive terminals, and
the second shielding member comprises a body at least partially held in the base portion and a plurality of extensions extending from and transverse to the body and out of the base portion and closer to the second contact portions of the second plurality of conductive elements.

12. The card edge connector of claim 11, wherein:
the second shielding member comprises a plurality of connection portions,
each of the plurality of connection portions extends from the body of the second shielding member towards a corresponding one ground terminal of the plurality of ground terminals and is electrically connected to the corresponding one ground terminal at the intermediate portions, and
the plurality of connection portions of the second shielding member are offset from the plurality of connection portions of the first shielding member in the longitudinal direction.

13. The card edge connector of claim 11, further comprising:
a third shielding member disposed in the base portion between the first row and the second row and electrically connected to the first shielding member and the second shielding member.

14. The card edge connector of claim 13, wherein:
the third shielding member is made of a lossy material.

15. The card edge connector of claim 13, wherein:
the third shielding member is electrically connected to the plurality of ground terminals at the intermediate portions.

16. The card edge connector of claim 11, further comprising:
a first receiving portion and a second receiving portion extending from the base portion at opposite ends of the base portion, respectively, wherein:
the first receiving portion and the second receiving portion are configured to guide, receive and/or retain edges of a printed circuit board, and
when the edges of the printed circuit board are received in the first receiving portion and the second receiving portion, a portion of the printed circuit board is disposed between the second contact portions of the first row and the second row.

17. An electrical connector comprising:
a housing comprising a base portion extending in a longitudinal direction, a socket recessed into the base portion in a mating direction perpendicular to the longitudinal direction, and a pair of guide members extending from the base portion in the mating direction;
a plurality of conductive elements held in the housing and disposed in a row extending in the longitudinal direction, the plurality of conductive terminals each comprising a first contact portion curving into the socket, and a second contact portion opposite the first contact portion and disposed outside the base portion and between the pair of guide members; and
a shielding member at least partially held in the base portion and extending at least from the first contact portions of the plurality of conductive elements to the second contact portions of the plurality of conductive elements.

18. The electrical connector of claim 17, wherein:
the plurality of conductive elements comprise a plurality of pairs of signal terminals and a plurality of ground terminals dispersed between the pairs,
the shielding member comprises a body, a plurality of first extensions extending from the body and each disposed to overlap one pair of the plurality of pairs of signal terminals, and a plurality of second extensions extending from the body and each disposed corresponding to one of the plurality of ground terminals, and
the plurality of second extensions each comprises a slot disposed to overlap a respective one of the plurality of ground terminals.

19. The electrical connector of claim 18, wherein the shielding member comprises
a plurality of connection portions configured to make contact with portions of the plurality of ground terminals in the base portion of the housing, and
a plurality of extension extending out of the base portion and closer to the second contact portions of the plurality of conductive elements.

20. An electronic system, comprising:
an electrical connector of claim 16;
a first printed circuit board inserted into the socket of the electrical connector, the first printed circuit board comprising a first plurality of contact pads configured to make contact with the first contact portions of the plurality of conductive terminals; and
a second printed circuit board inserted between the pair of guide members, the second printed circuit board comprising a second plurality of contact pads configured to make contact with the second contact portions of the plurality of conductive terminals, wherein
the shielding member of the electrical connector is separated from the first and second printed circuit boards by the plurality of conductive elements.
